(19) United States
(12) Patent Application Publication
(10) Pub. No.: US 2009/0248407 A1
(43) Pub. Date: Oct. 1, 2009

(54) SOUND ENCODER, SOUND DECODER, AND THEIR METHODS

(75) Inventor: Masahiro Oshikiri, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/295,338

(22) PCT Filed: Mar. 29, 2007
(86) PCT No.: PCT/JP2007/056952

§ 371 Date: Nov. 13, 2008

(30) Foreign Application Priority Data
Mar. 31, 2006 (JP) 2006-099915

(51) Int. Cl. G10L 21/02

(52) U.S. Cl. 704/226; 704/E21.002

(57) ABSTRACT

A sound encoder enabling prevention of deterioration of the sound quality of a reproduced signal even if the harmonic structure is broken in a part of the sound signal. The filter state position determining section (111) of the sound encoder judges the noise characteristic of the first-layer decoding spectrum and thereby determines the band of the first-layer decoding spectrum to be used to set the filter state. A filter state setting section (112) sets the first-layer decoding spectrum contained in the determined band out of the first-layer decoding spectrum as the filter state. A filtering section (113) performs filtering of the first-layer decoding spectrum according to the set filter state and the pitch coefficient and computes an estimate spectrum of the input spectrum. An optimal pitch coefficient is determined by a closed loop processing from the filtering section (113) through a search section (114) to a filter information setting section (115).

### TECHNICAL FIELD

The present invention relates to a speech coding apparatus, speech decoding apparatus, speech coding method and speech decoding method.

### BACKGROUND ART

To effectively utilize radio wave resources in a mobile communication system, compressing speech signals at a low bit rate is demanded. On the other hand, users expect to improve the quality of communication speech and implement communication services with high fidelity. To implement these, it is preferable not only to improve the quality of speech signals, but also to be capable of efficiently encoding signals other than speech, such as audio signals having a wider band.

For such contradictory demands, an approach of hierarchically incorporating a plurality of coding techniques is expected. To be more specific, a configuration is taken into consideration combining in a layered manner the first layer for encoding an input signal at a low bit rate by a model suitable for a speech signal and the second layer for encoding a residual signal between the input signal and the first layer decoded signal by a model suitable for a wide variety of signals including a speech signal. A coding scheme having such a layered structure has scalability in bit streams acquired in a coding section, that is, this coding scheme has the characteristics of acquiring a decoded signal with certain quality from partial information even when part of bit streams is lost, and, consequently, is referred to as “scalable coding.” Scalable coding having such characteristic can flexibly support communication between networks having different bit rates, and is therefore appropriate for a future network environment incorporating various networks by IP (Internet Protocol).

An example of conventional scalable coding techniques is disclosed in Non-Patent Document 1. Non-Patent document 1 discloses scalable coding using the technique standardized in moving picture experts group phase-4 (“MPEG-4”). To be more specific, in the first layer, code excited linear prediction (“CELP”) coding suitable for a speech signal is used, and, in the second layer, transform coding such as advanced audio coder (“AAC”) and transform domain weighted interleave vector quantization (“TwinVQ”) is used for a residual signal acquired by removing a first layer decoded signal from an original signal.

Further, as for transform coding, Non-Patent document 2 discloses a technique of encoding the high band of a spectrum efficiently. Non-Patent Document 2 discloses using the high band of a spectrum as an output signal of a pitch filter utilizing the low band of the spectrum as the filter state of the pitch filter. Thus, by encoding filter information on a pitch filter with the small number of bits, it is possible to realize a low bit rate.

Non-patent document 1: “Everything for MPEG-4 (first edition),” written by Miki Sukeichi, published by Kogyo Chosakai Publishing, Inc., Sep. 30, 1998, pages 126 to 127
Non-patent Document 2: “Scalable speech coding method in 7/10/15 kHz band using band enhancement techniques by pitch filtering,” Acoustic Society of Japan, March 2004, pages 327 to 328

### DISCLOSURE OF INVENTION

### Problem to be Solved by the Invention

FIG. 1 illustrates the spectral characteristics of a speech signal. As shown in FIG. 1, a speech signal has the harmonic structure where peaks of the spectrum occur at fundamental frequency F0 and its integral multiples. Non-Patent Document 2 discloses a technique of utilizing the low band of a spectrum such as 0 to 4000 HZ band, as the filter state of a pitch filter and encoding the high band of the spectrum such that the harmonic structure in the high band such as 4000 to 7000 Hz band is maintained. By this means, the harmonic structure of the speech signal is maintained, so that it is possible to perform coding with high sound quality.

However, in part of a speech signal, the harmonic structure may be collapsed. That is, there may be a case where the harmonic structure exists in only part of the low band and collapses in frequencies other than the low band. This example will be explained using FIG's. 2 to 4. FIG. 2 illustrates a speech waveform, FIG. 3 illustrates the spectral characteristics of the speech waveform of FIG. 2 and FIG. 4 illustrates a spectrum generated by the coding/decoding processing of Non-Patent Document 2. FIG. 2 shows a waveform similar to a sine wave. Consequently, as shown in FIG. 3, although a harmonic structure exists in 1000 Hz or the lower band, the harmonic structure is collapsed in higher frequencies than 1000 Hz. When the spectrum in the high band is generated from speech having such characteristics using the technique of Non-Patent Document 2, spectrum peaks occur in part of the high band (which is around 4000 Hz in the example of FIG. 4), thereby causing sound degradation. This phenomenon is caused by utilizing spectrum peaks, such as ones in 0 to 1000 Hz band of FIG. 3, included in the filter state of the pitch filter upon generating the spectrum in the high band such as 4000 to 7000 Hz band.

Thus, in a case where the harmonic structure is collapsed in part of a speech signal, when the technique of Non-Patent Document 2 is adopted, there is a problem of degrading sound quality of a decoded signal generated in a decoding section.

It is therefore an object of the present invention to provide a speech coding apparatus or the like that prevents sound degradation of a decoded signal even when the harmonic structure is collapsed in part of a speech signal.

### Means for Solving the Problem

The speech coding apparatus of the present invention employs a configuration having: a first coding section that encodes a low band of an input signal and generates first encoded data; a first decoding section that decodes the first encoded data and generates a first decoded signal; a second coding section that sets a filter state of a filter based on a spectrum of the first decoded signal and generates second encoded data by encoding a high band of the input signal using the filter; and a determining section that determines a band of the spectrum of the first decoded signal that is used to set the filter state of the filter, according to noise characteristics of the spectrum of the first decoded signal, and in which the second coding section sets the filter state of the filter based on the spectrum of the first decoded signal of the determined band.

The speech decoding apparatus of the present invention employs a configuration having: a first decoding section that generates a first decoded signal by decoding first encoded data of a signal comprised of a low band indicated by the first encoded data and a high band indicated by second encoded data; a second decoding section that sets a filter state of a filter based on a spectrum of the first decoded signal and decodes the high band of the signal by decoding the second encoded data using the filter; and a determining section that determines a band of the spectrum of the first decoded signal that is used to set the filter state of the filter, according to noise characteristics of the spectrum of the first decoded signal, and in which the second decoding section sets the filter state of the filter based on the spectrum of the first decoded signal in the determined band.

### ADVANTAGEOUS EFFECT OF THE INVENTION

According to the present invention, it is possible to prevent sound degradation of a decoded signal even when the harmonic structure is collapsed in part of a speech signal.

### BRIEF DESCRIPTION OF DRAWINGS

FIG. 1 illustrates the spectral characteristics of a speech signal;

FIG. 2 illustrates a speech waveform;

FIG. 3 illustrates the spectral characteristics of the speech waveform of FIG. 2;

FIG. 4 illustrates a spectrum generated by the coding/decoding processing of Non-Patent Document 2;

FIG. 5 is a block diagram showing main components of a speech coding apparatus according Embodiment 1 of the present invention;

FIG. 6 is a block diagram showing main components inside a second layer coding section according to Embodiment 1;

FIG. 7 illustrates a method of determining the band of the first layer decoded spectrum that is used to set the filter state;

FIG. 8 illustrates another example of determining the band of the first layer spectrum band that is used to set the filter state;

FIG. 9 illustrates filtering processing in a filtering section according to Embodiment 1 in detail;

FIG. 10 is a block diagram showing main components of a speech decoding apparatus according to Embodiment 1;

FIG. 11 is a block diagram showing main components inside a second layer decoding section according to Embodiment 1;

FIG. 12 is a block diagram showing another configuration of a speech coding apparatus according to Embodiment 1;

FIG. 13 is a block diagram showing main components of a speech decoding apparatus supporting the speech coding apparatus of FIG. 12;

FIG. 14 is a block diagram showing main components of a speech coding apparatus according to Embodiment 2 of the present invention;

FIG. 15 is a block diagram showing main components inside a second layer coding section according to Embodiment 2;

FIG. 16 illustrates processing in a second layer coding section according to Embodiment 2;

FIG. 17 is a block diagram showing main components of a speech decoding apparatus according to Embodiment 2;

FIG. 18 is a block diagram showing main components inside a second layer decoding section according to Embodiment 2;

FIG. 19 illustrates a state where the energy of a spectrum envelope increases in a band in which the harmonic structure exists; and

FIG. 20 illustrates an example of a band determined by a filter state position determining section according to Embodiment 3.

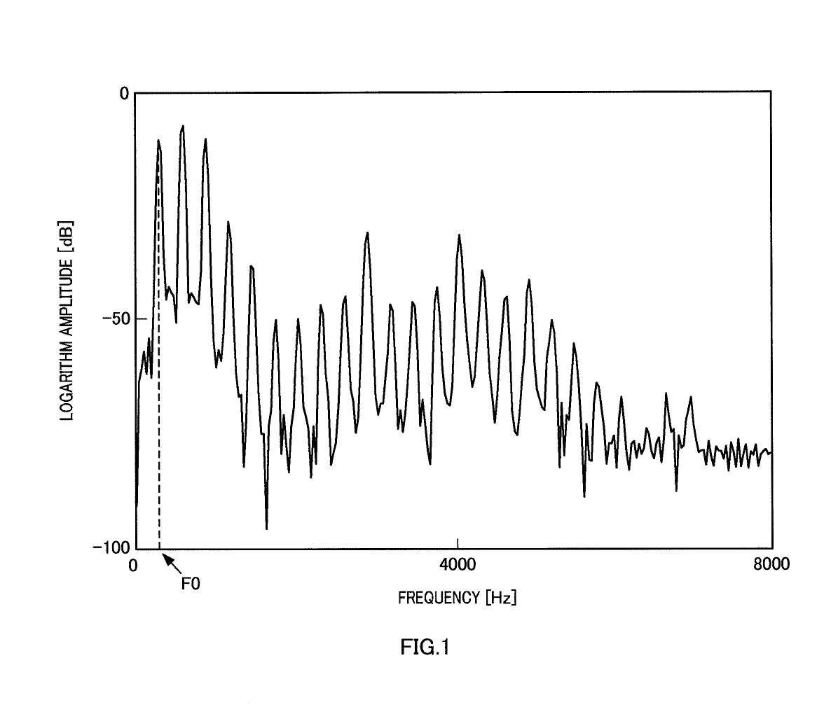

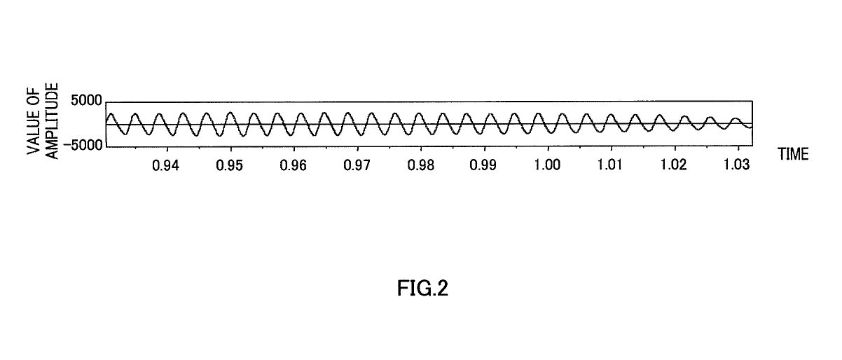

### BEST MODE FOR CARRYING OUT THE INVENTION

Embodiments of the present invention will be explained below in detail with reference to the accompanying drawings.

### Embodiment 1

FIG. 5 is a block diagram showing main components of speech coding apparatus 100 according to Embodiment 1 of the present invention.

Speech coding apparatus 100 is configured with frequency domain transform section 101, first layer coding section 102, first layer decoding section 103, second layer coding section 104 and multiplexing section 105, and performs frequency domain coding in the first layer and the second layer.

The sections of speech coding apparatus 100 perform the following operations.

Frequency domain transform section 101 performs frequency analysis for an input signal and calculates the spectrum of the input signal (i.e., input spectrum) in the form of transform coefficients. To be more specific, for example, frequency domain transform section 101 transforms a time domain signal into a frequency domain signal using the modified discrete cosine transform (“MDCT”). The input spectrum is outputted to first layer coding section 102 and second layer coding section 104.

First layer coding section 102 encodes the low band of the input spectrum [0≦k<FL] using, for example, TwinVQ, and outputs the first layer encoded data acquired by this coding to first layer decoding section 103 and multiplexing section 105.

First layer decoding section 103 generates the first layer decoded spectrum by decoding the first layer encoded data and outputs the first layer decoded spectrum to second layer coding section 104. Here, first layer decoding section 103 outputs the first layer decoded spectrum that is not transformed into a time domain spectrum.

Second layer coding section 104 encodes the high band [FL≦k<FH] of the input spectrum [0≦k<FH] outputted from frequency domain transform section 101 using the first layer decoded spectrum acquired in first layer decoding section 103, and outputs the second layer encoded data acquired by this coding to multiplexing section 105. To be more specific, second layer coding section 104 estimates the high band of the input spectrum by pitch filtering processing using the first layer decoded spectrum as the filter state of the pitch filter. At this time, second layer coding section 104 estimates the high band of the input spectrum such that the harmonic structure of the spectrum does not collapse. Further, second layer coding section 104 encodes filter information of the pitch filter. Second layer coding section 104 will be described later in detail.

Multiplexing section 105 multiplexes the first layer encoded data and the second layer encoded data and outputs the resulting encoded data. This encoded data is superimposed over bit streams through, for example, the transmission processing section (not shown) of a radio transmitting apparatus having speech coding apparatus 100 and is transmitted to a radio receiving apparatus.

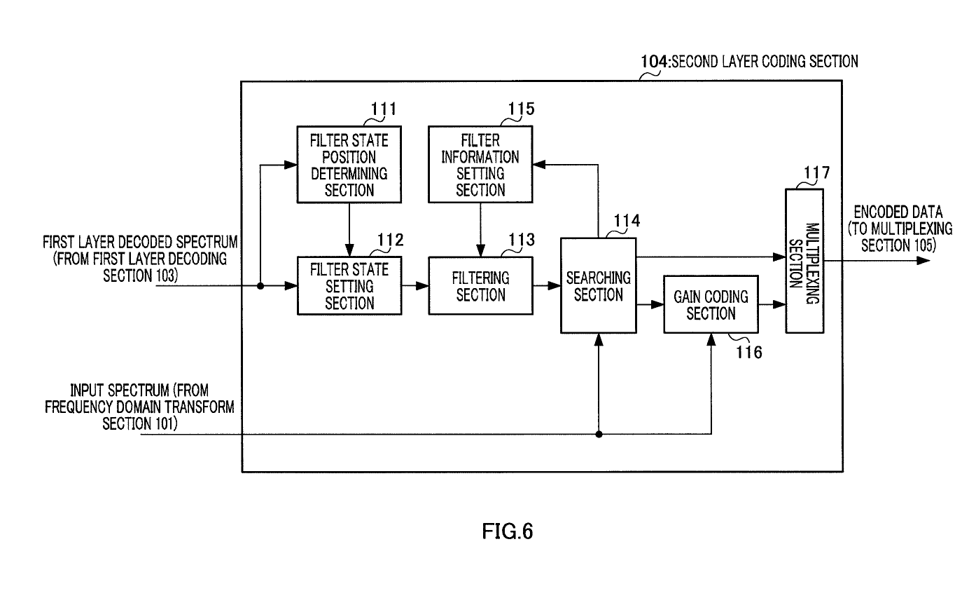

FIG. 6 is a block diagram showing main components inside above second layer coding section 104.

Second layer coding section 104 is configured with filter state position determining section 111, filter state setting section 112, filtering section 113, searching section 114, filter information setting section 115, gain coding section 116 and multiplexing section 117, and these sections perform the following operations.

Filter state position determining section 111 determines the noise characteristics of the first layer decoded spectrum outputted from first layer decoding section 103 and determines the band of the first layer decoded spectrum that is used to set the filter state of filtering section 113. To be more specific, the filter state of filtering section 113 refers to the internal state of the filter used in filtering section 113. Filter state position determining section 111 determines the band of the first layer decoded spectrum that is used to set the filter state by dividing the first layer decoded spectrum into a plurality of subbands, determining the noise characteristics on a per subband basis and deciding determination results of all subbands comprehensively, and outputs frequency information showing the determined band to filter state setting section 112. The method of determining the noise characteristics and the method of determining the band of the first layer decoded spectrum will be described later in detail.

Filter state setting section 112 sets the filter state based on the frequency information outputted from filter state position determining section 111. As the filter state, in the first layer decoded spectrum S1(k), the first layer decoded spectrum included in the band determined in filter state position determining section 111 is used.

Filtering section 113 calculates the estimated spectrum S2′(k) of the input spectrum by filtering the first layer decoded spectrum, based on the filter state of the filter set in filter state setting section 112 and the pitch coefficient T outputted from filter information setting section 115. This filtering will be described later in detail.

Filter information setting section 115 changes the pitch coefficient T little by little in the predetermined search range between Tₘᵢₙ and Tₘₐₓ under the control of searching section 114, and outputs the results in order, to filtering section 113.

Searching section 114 calculates the similarity between the high band [FL≦k<FH] of the input spectrum S2(k) outputted from frequency domain transform section 101 and the estimated spectrum S2′(k) outputted from filtering section 113. This calculation of the similarity is performed by, for example, correlation computation. The processing between filtering section 113, searching section 114 and filter information setting section 115 is the closed-loop processing. Searching section 114 calculates the similarity matching each pitch coefficient by changing the pitch coefficient T outputted from filter information setting section 115, and outputs the optimal pitch coefficient T′ (between Tₘᵢₙ and Tₘₐₓ) for maximizing the calculated similarity to multiplexing section 117. Further, searching section 114 outputs the estimation value S2′(k) of the input spectrum associated with this pitch coefficient T′ to gain coding section 116.

Gain coding section 116 calculates gain information of the input spectrum S2(k) based on the high band (FL≦k<FH) of the input spectrum S2(k) outputted from frequency domain transform section 101. To be more specific, gain information is expressed by the spectrum power per subband and the frequency band FL≦k<FH is divided into J subbands. In this case, the spectrum power B(j) of the j-th subband is expressed by following equation 1.

$$\begin{matrix}( Equation 1 ) & \\ B ( j ) = {\sum }_{k = BL ( j )}^{BH ( j )} S 2 {( k )}^{2} & [ 1 ]\end{matrix}$$

In equation 1, BL(j) is the lowest frequency in the j-th subband and BH(j) is the highest frequency in the j-th subband. Subband information of the input spectrum calculated as above is referred to as gain information. Further, similarly, gain coding section 116 calculates subband information B′(j) of the estimation value S2′(k) of the input spectrum according to following equation 2 and calculates the variation V(j) per subband according to following equation 3.

$$\begin{matrix}( Equation 2 ) & \\ {B}^{′} ( j ) = {\sum }_{k = BL ( j )}^{BH ( j )} S {2}^{′} {( k )}^{2} & [ 2 ] \\ ( Equation 3 ) & \\ V ( j ) = \sqrt{\frac{B ( j )}{{B}^{′} ( j )}} & [ 3 ]\end{matrix}$$

Further, gain coding section 116 encodes the variation V(j) and outputs an index associated with the encoded variation V_{q}(j), to multiplexing section 117.

Multiplexing section 117 multiplexes the optimal pitch coefficient T′ outputted from searching section 114 and the index of variation V(j) outputted from gain coding section 116, and outputs the resulting second layer encoded data to multiplexing section 105.

Next, the processing in filter state position determining section 111 will be explained.

The noise characteristics of the first layer decoded spectrum are determined as follows. Filter state position determining section 111 divides the first layer decoded spectrum into a plurality of subbands and determines the noise characteristics on a per subband basis. These noise characteristics are determined using, for example, the spectral flatness measure (“SFM”). The SFM is expressed by the ratio of an arithmetic average of an amplitude spectrum with respect to a geometric average of the amplitude spectrum (=geometric average/arithmetic average), and approaches 0.0 when the peak characteristics of the spectrum become significant and approaches 1.0 when the noise characteristics become significant. A comparison is performed between a threshold for determination of the noise characteristics and the SFM. The noise characteristics are decided significant when the SFM is greater than the threshold and the peak characteristics are decided significant (i.e., the harmonic structure is significant) when the SFM is not greater than the threshold. Further, as another method of determining the noise characteristics, it is equally possible to calculate a variance value after energy of an amplitude spectrum is normalized and compare a threshold and the calculated variance value as an index of the noise characteristics.

Further, filter state position determining section 111 classifies determination results of the noise characteristics of subbands into a plurality of predetermined noise characteristic patterns and determines the band of the first layer decoded spectrum that is used to set the filter state based on the classification results using the following method.

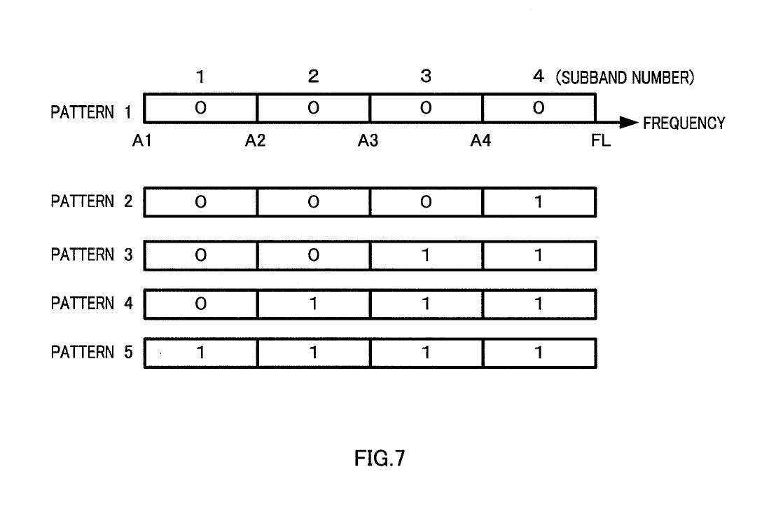

FIG. 7 illustrates a method of determining the band of the first layer decoded spectrum that is used to set the filter state. In this figure, the number of subbands is 4, and a subband decided to have significant noise characteristics is assigned “1” and a subband decided to have insignificant noise characteristics (i.e., a harmonic structure is significant) is assigned “0.”

In pattern 1, all of subbands are decided to have insignificant noise characteristics (i.e., a harmonic structure is significant). In this case, a harmonic structure is decided to exist in the band that is encoded in second layer coding section 104, that is, a harmonic structure is decided to exist in the band of higher frequency than FL, and filter state position determining section 111 outputs information showing frequency A1.

In patterns 2 to 5, high subbands are decided to have significant noise characteristics. In this case, a spectrum with significant noise characteristics is decided to exist in the band that is encoded in second layer coding section 104, that is, a spectrum with significant noise characteristics is decided to exist in the band of higher frequency than FL, and filter state position determining section 111 outputs information showing frequency A4 in pattern 2, information showing frequency A3 in pattern 3, information showing frequency A2 in pattern 4 and information showing frequency A1 in pattern 5.

When determination results of the noise characteristics of subbands, that is, the noise characteristics of the first layer decoded spectrum do not match with patterns 1 to 5, by adopting rules such as prioritizing the determination results of subbands in the low band, the noise characteristics of the first layer decoded spectrum are made to match with one of patterns 1 to 5.

Filter state position determining section 111 outputs information showing one of frequencies A1 to A4, to filter state setting section 112. Filter state setting section 112 uses the first layer spectrum as the filter state, in the range of An≦k<FL in the first layer decoded spectrum S1(k). Here, An represents one of A1 to A4.

Further, the appropriate search range between Tₘᵢₙ and Tₘₐₓ for the pitch coefficient T in filter information setting section 115 is set in advance so as to match with output results A1 to A4 in filter state position determining section 111, and satisfies the relationship of 0<Tₘᵢₙ<Tₘₐₓ≦FL−An.

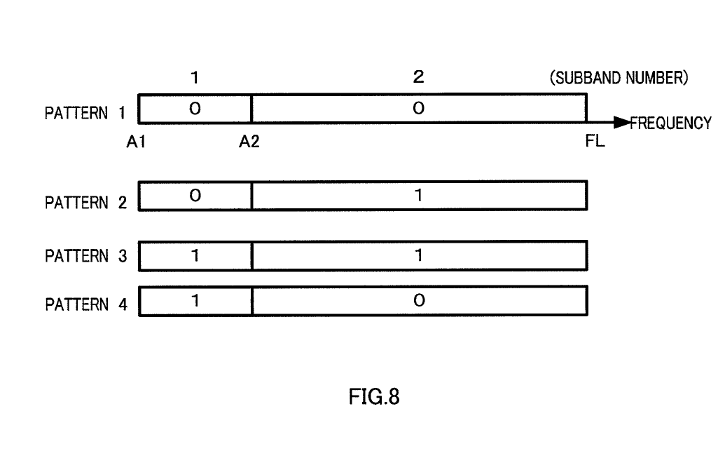

FIG. 8 illustrates another example of a determination method of the band of the first layer decoded spectrum that is used to set the filter state. Here, the number of subbands is 2, and the bandwidth of a subband in the low band is narrower than in the high band.

In pattern 1, all subbands are decided to have insignificant noise characteristics (i.e., a harmonic structure is significant). Consequently, a harmonic structure is decided to exist in the band that is encoded in second layer coding section 104 and that is the band of higher frequency than FL, and filter state position determining section 111 outputs information showing frequency A1.

In patterns 2 and 3, the high subband is decided to have significant noise characteristics. Consequently, a spectrum with significant noise characteristics is decided to exist in the band that is encoded in second layer coding section 104 and that is the band of higher frequency than FL, and filter state position determining section 111 outputs information showing frequency A2 in pattern 2 and information showing A1 in pattern 3.

In pattern 4, by adopting a rule of prioritizing the determination result of the subband in the low frequency, filter state position determining section 111 outputs information showing A1.

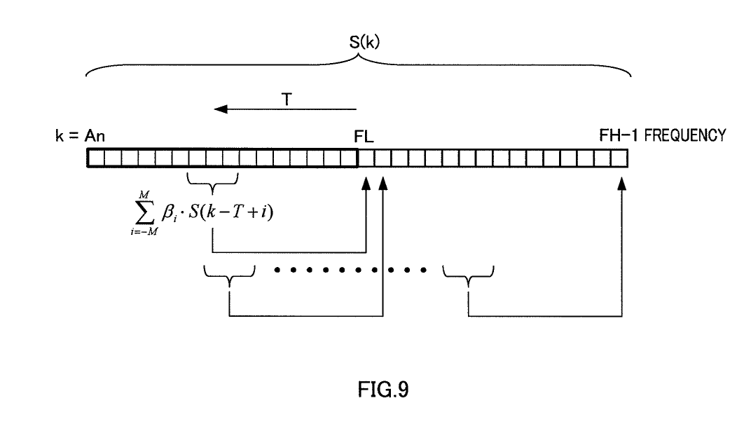

Next, the filtering processing in filtering section 113 will be explained in detail using FIG. 9.

Filtering section 113 generates the spectrum in the band FL≦k<FH, using the pitch coefficient T outputted from filter information setting section 115. Here, the spectrum of the whole frequency band (0≦k<FH) is referred to as “S(k)” for ease of explanation, and the result of following equation 4 is used as the filter function.

$$\begin{matrix}( Equation 4 ) & \\ P ( z ) = \frac{1}{1 - {\sum }_{i = - M}^{M} {β}_{i} {z}^{- T + i}} & [ 4 ]\end{matrix}$$

In this equation, T is the pitch coefficient given from filter information setting section 115, βᵢ is the filter coefficient and M is 1.

The band of An≦k<FL in S(k) stores the first layer decoded spectrum S1(k) as the filter state of the filter. Here, “An” represents one of A1 to A4 and is determined by filter state position determining section 111.

The band of FL≦k<FH in S(k) stores the estimation value S2′(k) of an input spectrum by filtering processing of the following steps. The spectrum S(k−T) that is lower than k by T, is assigned to this S2′(k). However, to improve the smooth continuity of the spectrum, it is equally possible to assign to S2′(k), the sum of spectrums acquired by assigning all i's to spectrum βᵢ*S(k−T+i) multiplying spectrum S(k−T+i) that is close to and separated by i from spectrum S(k−T) by predetermined filter coefficient βᵢ. This processing is expressed by following equation 5.

$$\begin{matrix}( Equation 5 ) & \\ S {2}^{′} ( k ) = {\sum }_{i = - 1}^{1} {β}_{i} \cdot S ( k - T + i ) & [ 5 ]\end{matrix}$$

By performing the above computation changing frequency k in the range of FL≦k<FH in order from the lowest frequency FL, estimation values S2′(k) of the input spectrum in FL≦k<FH are calculated.

The above filtering processing is performed zero-clearing the S(k) in the range of FL≦k<FH every time filter information setting section 115 produces the pitch coefficient T. That is, S(k) is calculated and outputted to searching section 114 every time the pitch coefficient T changes.

As described above, in a case where a harmonic structure is collapsed in part of the spectrum of an input signal, by determining the spectrum that is used to set the filter state according to the noise characteristics of the first layer decoded spectrum, speech coding apparatus 100 according to the present embodiment can use as the filter state, the low-band spectrum excluding the band in which a harmonic structure exists, so that it is possible to prevent an occurrence of unnecessary spectrum peaks in an estimated spectrum and improve the sound quality of a decoded signal in the speech decoding apparatus supporting speech coding apparatus 100.

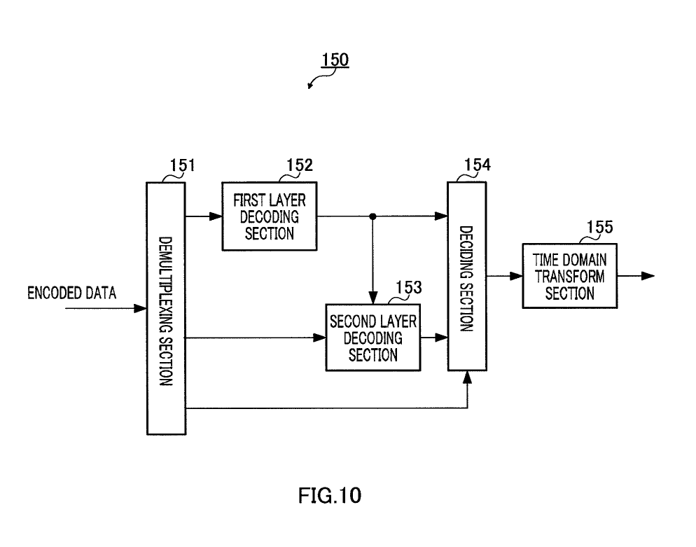

Next, speech decoding apparatus 150 of the present embodiment supporting speech coding apparatus 100 will be explained. FIG. 10 is a block diagram showing main components of speech decoding apparatus 150. This speech decoding apparatus 150 decodes encoded data generated in speech coding apparatus 100 shown in FIG. 5. The sections of speech decoding apparatus 150 perform the following operations.

Demultiplexing section 151 demultiplexes encoded data superimposed over bit streams transmitted from a radio transmitting apparatus into the first layer encoded data and the second layer encoded data, and outputs the first layer encoded data to first layer decoding section 152 and the second later encoded data to second layer decoding section 153. Further, demultiplexing section 151 demultiplexes from the bit streams, layer information showing to which layer the encoded data included in the above bit streams belongs, and outputs the layer information to deciding section 154.

First layer decoding section 152 generates the first layer decoded spectrum S1(k) by performing decoding processing on the first layer encoded data and outputs the result to second layer decoding section 153 and deciding section 154.

Second layer decoding section 153 generates the second layer decoded spectrum using the second layer encoded data and the first layer decoded spectrum S1(k), and outputs the result to deciding section 154. Here, second layer decoding section 153 will be described later in detail.

Deciding section 154 decides, based on the layer information outputted from demultiplexing section 151, whether or not the encoded data superimposed over the bit streams includes second layer encoded data. Here, although a radio transmitting apparatus having speech coding apparatus 100 transmit bit streams including first layer encoded data and second layer encoded data, the second layer encoded data may be lost in the middle of the communication path. Therefore, deciding section 154 decides, based on the layer information, whether or not the bit streams include second layer encoded data. Further, if the bit streams do not include second layer encoded data, second layer decoding section 153 do not generate the second layer decoded spectrum, and, consequently, deciding section 154 outputs the first layer decoded spectrum to time domain transform section 155. However, in this case, to match the order of the first layer decoded spectrum to the order of a decoded spectrum acquired by decoding bit streams including the second layer encoded data, deciding section 154 extends the order of the first layer decoded spectrum to FH, sets and outputs the spectrum in the band between FL and FH as 0. On the other hand, when the bit streams include the first layer encoded data and the second layer encoded data, deciding section 154 outputs the second layer decoded spectrum to time domain transform section 155.

Time domain transform section 155 generates a decoded signal by transforming the decoded spectrum outputted from deciding section 154 into a time domain signal and outputs the decoded signal.

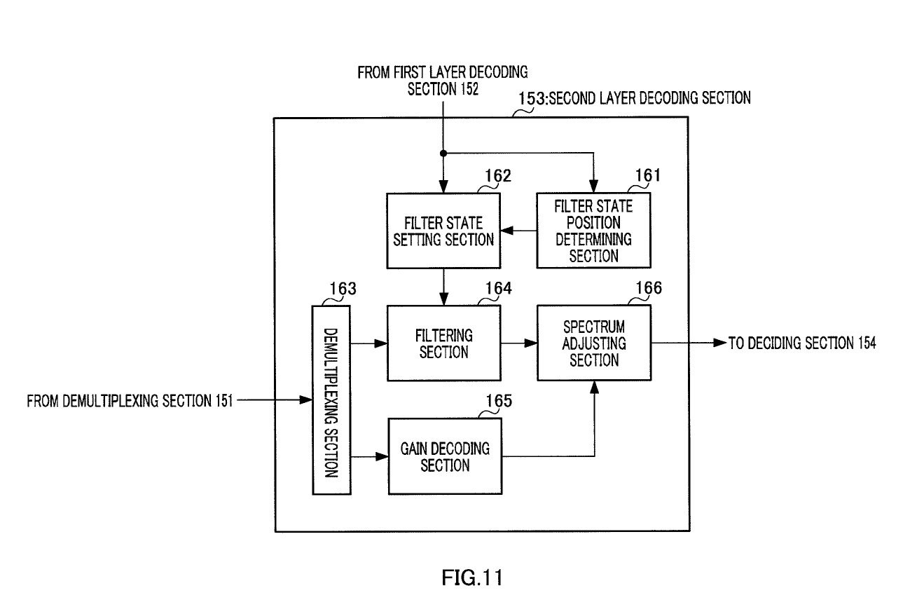

FIG. 11 is a block diagram showing main components inside above second layer decoding section 153.

Filter state position determining section 161 employs a configuration corresponding to the configuration of filter state position determining section 111 in speech coding apparatus 100. Filter state position determining section 161 determines the noise characteristics of the first layer decoded spectrum from one of a plurality of predetermined noise characteristics patterns by dividing the first layer decoded spectrum S1(k) outputted from first layer decoding section 152 into a plurality of subbands and deciding the noise characteristics per subband. Further, filter state position determining section 161 determines the band of the first layer decoded spectrum that is used to set the filter state, and outputs frequency information showing the determined band (one of A1 to A4) to filter state setting section 162.

Filter state setting section 162 employs a configuration corresponding to the configuration of filter state setting section 112 in speech coding apparatus 100. Filter state setting section 162 receives as input, the first layer decoded spectrum S1(k) from first layer decoding section 152. Filter state setting section 162 sets the first layer decoded spectrum in An≦k<FL (“An” is one of A1 to A4) in this first layer decoded spectrum S1(k), as the filter state that is used in filtering section 164.

On the other hand, demultiplexing section 163 receives as input, the second layer encoded data from demultiplexing section 151. Demultiplexing section 163 demultiplexes the second layer encoded data into information about filtering (optimal pitch coefficient T′) and the information about gain (the index of variation V(j)), and outputs the information about filtering to filtering section 164 and the information about gain to gain decoding section 165.

Filtering section 164 filters the first layer decoded spectrum S1(k) based on the filter state set in filter state setting section 162 and the pitch coefficient T′ inputted from demultiplexing section 163, and calculates the estimated spectrum S2′(k) according to above equation 5. Filtering section 164 also uses the filter function shown in above equation 4.

Gain decoding section 165 decodes the gain information outputted from demultiplexing section 163 and calculates variation V_{q}(j) representing a quantization value of variation V(j).

Spectrum adjusting section 166 adjusts the shape of the spectrum in the frequency band FL≦k<FH of the estimated spectrum S2′(k) by multiplying the estimated spectrum S2′(k) outputted from filtering section 164 by the variation V_{q}(j) per subband outputted from gain decoding section 165 according to following equation 6, and generates the decoded spectrum S3(k). Here, the low band (0≦k<FL) of the decoded spectrum S3(k) is comprised of the first layer decoded spectrum S1(k) and the high band (FL≦k<FH) of the decoded spectrum S3(k) is comprised of the estimated spectrum S2′(k) after the adjustment. This decoded spectrum S3(k) after the adjustment is outputted to deciding section 154 as the second layer decoded spectrum.

[6]

S3(k)=S2′(k)·V_{q}(j)(BL(j)≦k≦BH(j), for all j) (Equation 6)

Thus, speech decoding apparatus 150 can decode encoded data generated in speech coding apparatus 100.

As described above, according to the present embodiment, in the coding method of efficiently encoding the high band of the spectrum using the low band of the spectrum, it is possible to determine the noise characteristics of the first layer decoded spectrum and determine the band of the spectrum that is used to set the filter state of a filter according to the determination result. To be more specific, the period in the low band where a harmonic structure is collapsed, that is, the band with significant noise characteristics in the low band is detected, and the high band is encoded using the detected band.

By this means, for a speech signal where the harmonic structure exists in part of the low band, the high band is generated using the spectrum in a band without a harmonic structure as the filter state, so that it is possible to realize a decoded signal with high quality. Further, to decide noise characteristics based on the first layer decoded spectrum in the speech decoding apparatus, the coding apparatus can realize a low bit rate in a transmission rate without transmitting additional information for specifying the spectrum that is used for the filter state.

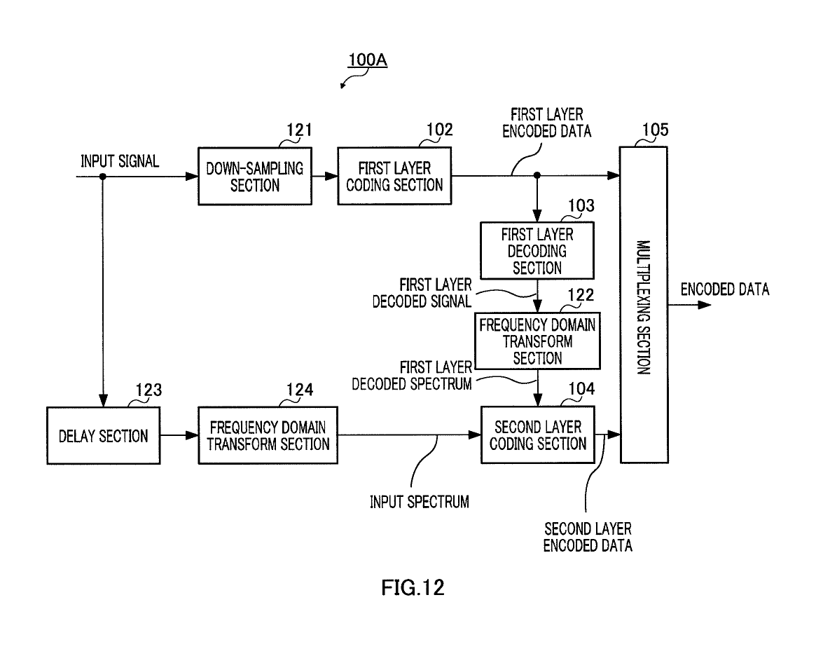

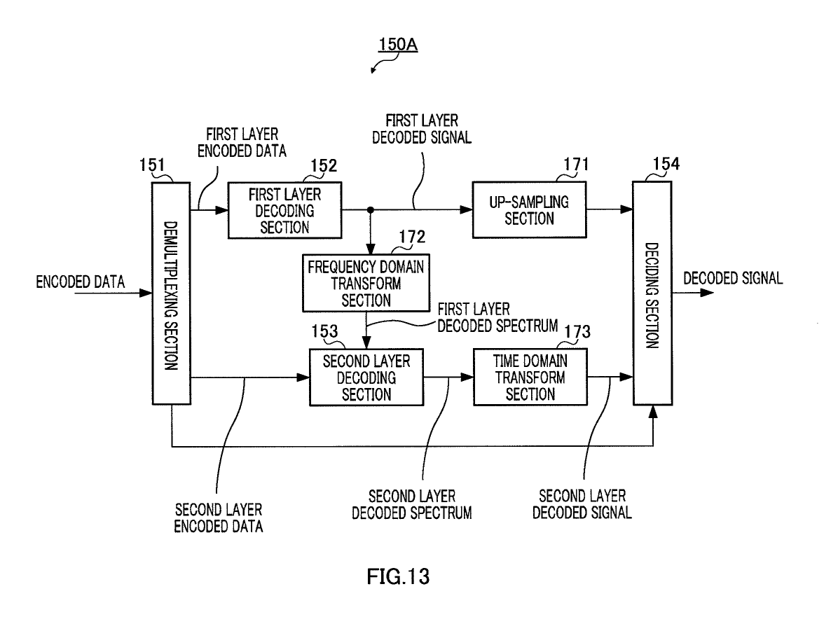

Further, in the present embodiment, the following configuration may be employed. FIG. 12 is a block diagram showing another configuration 100A of speech coding apparatus 100. Further, FIG. 13 is a block diagram showing main components of speech decoding apparatus 150A supporting speech coding apparatus 100. The same configurations as in speech coding apparatus 100 and speech decoding apparatus 150 will be assigned the same reference numerals and explanations will be naturally omitted.

In FIG. 12, down-sampling section 121 performs down-sampling for an input speech signal in the time domain and transforms a sampling rate to a desirable sampling rate. First layer coding section 102 encodes the time domain signal after down-sampling using CELP coding and generates first layer encoded data. First layer decoding section 103 decodes the first layer encoded data and generates a first layer decoded signal. Frequency domain transform section 122 performs frequency analysis for the first layer decoded signal and generates a first layer decoded spectrum. Delay section 123 provides the input speech signal with a delay matching the delay among down-sampling section 121, first layer coding section 102, first layer decoding section 103 and frequency domain transform section 122. Frequency domain transform section 124 performs frequency analysis for the input speech signal with the delay and generates an input spectrum. Second layer coding section 104 generates second layer encoded data using the first layer decoded spectrum and the input spectrum. Multiplexing section 105 multiplexes the first layer encoded data and the second layer encoded data, and outputs the resulting encoded data.

Further, in FIG. 13, first layer decoding section 152 decodes the first layer encoded data outputted from demultiplexing section 151 and acquires the first layer decoded signal. Up-sampling section 171 changes the sampling rate of the first layer decoded signal into the same sampling rate as of the input signal. Frequency domain transform section 172 performs frequency analysis for the first layer decoded signal and generates the first layer decode spectrum.

Second layer decoding section 153 decodes the second layer encoded data outputted from demultiplexing section 151 using the first layer decoded spectrum and acquires the second layer decoded spectrum. Time domain transform section 173 transforms the second layer decoded spectrum into a time domain signal and acquires a second layer decoded signal. Deciding section 154 outputs one of the first layer decoded signal and the second layer decoded signal based on the layer information outputted from demultiplexing section 154.

Thus, in the above variation, first layer coding section 102 performs coding processing in the time domain. First layer coding section 102 uses CELP coding for encoding a speech signal with high quality at a low bit rate. Therefore, first layer coding section 102 uses the CELP coding, so that it is possible to reduce the overall bit rate of the scalable coding apparatus and realize high quality. Further, CELP coding can reduce an inherent delay (algorithms delay) compared to transform coding, so that it is possible to reduce the overall inherent delay of the scalable coding apparatus and realize speech coding processing and decoding processing suitable to mutual communication.

### Embodiment 2

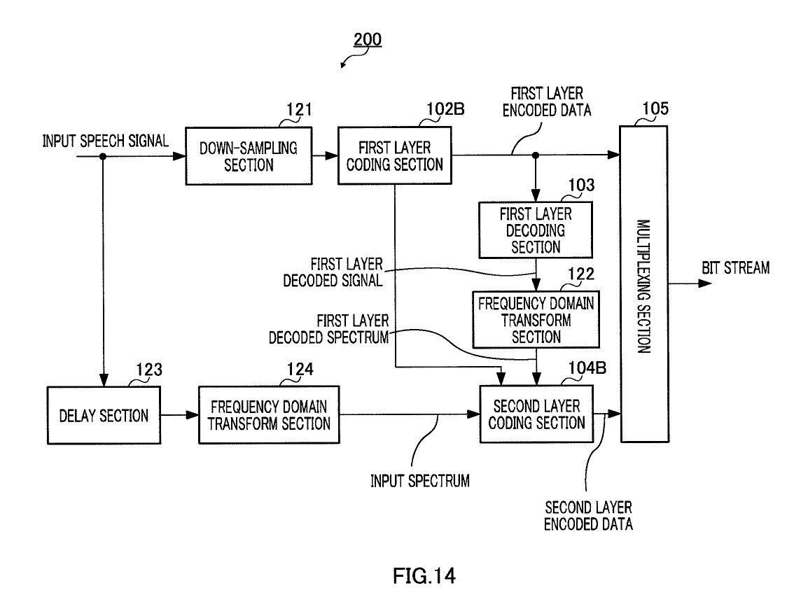

FIG. 14 is a block diagram showing main components of speech coding apparatus 200 according to Embodiment 2 of the present invention. Further, this speech coding apparatus 200 has the same basic configuration as speech coding apparatus 100A (see FIG. 12) shown in Embodiment 1, and the same components as speech coding apparatus 100A will be assigned the same reference numerals and explanations will be omitted.

Further, the components having the same basic operation but having detailed differences will be assigned the same reference numerals and lower-case letters of alphabets for distinction, and will be explained where necessary.

Speech coding apparatus 200 is different from speech coding apparatus 100A shown in Embodiment 1 in that first layer coding section 102B outputs a pitch period found in coding processing to second layer coding section 104B and second layer coding section 104B determines the noise characteristics of a decoded spectrum using the inputted pitch period.

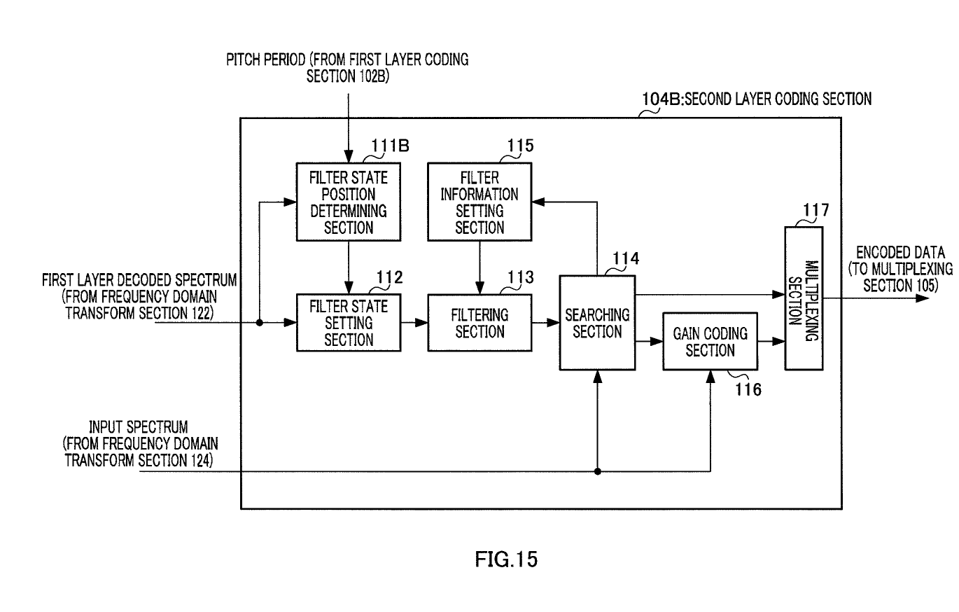

FIG. 15 is a block diagram showing main components inside second layer coding section 104B.

Filter state position determining section 111B having different configuration from the filter state position determining section 111B in Embodiment 1 calculates the pitch frequency from the pitch period found in first layer coding section 102B and uses the pitch frequency as fundamental frequency F0. Next, filter state position determining section 111B calculates the variations between the amplitude values of the first layer decoded spectra at integral multiples of fundamental frequency F0, specifies a frequency at which the variation decreases significantly and outputs information showing this frequency to filter state setting section 112.

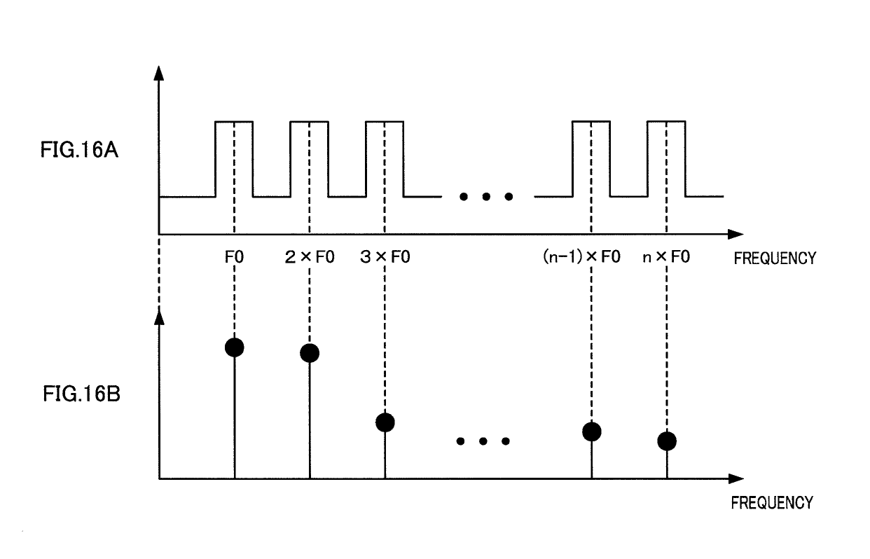

FIG. 16 illustrates the above processing in second layer coding section 104B.

Second layer coding section 104B sets subbands with center frequencies at fundamental frequency F0 and its integral multiples, as shown in FIG. 16A. Next, second layer coding section 104B calculates average values of the amplitude values of the first layer decoded spectra of these subbands, compares the variations of these average values in the frequency domain and a threshold, and outputs information showing the frequencies at which the variations are greater than the threshold. For example, when average values of the amplitude spectrum are as shown in FIG. 16B, the average value of the amplitude spectrum changes significantly at frequency 3×F0. If this variation is greater than the threshold, information showing frequency 3×F0 is outputted. Here, this method is likely to be influenced by the spectrum envelope (i.e., the component in which the spectrum gradually changes), and, consequently, the above processing may be performed after normalization using the spectrum envelope (i.e., flattering the spectrum). In this case, it is possible to acquire information of a frequency more accurately.

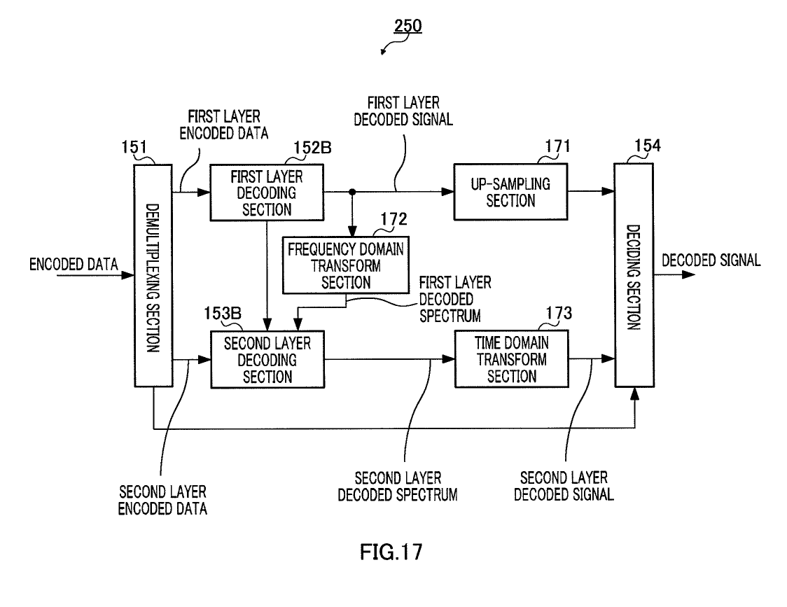

FIG. 17 is a block diagram showing main components of speech decoding apparatus 250 according to the present embodiment. Further, this speech decoding apparatus 250 has the same basic configuration as speech decoding apparatus 150A (see FIG. 13) shown in Embodiment 1, and the same components as speech decoding apparatus 150A will be assigned the same reference numerals and explanations will be omitted.

Speech decoding apparatus 250 is different from speech decoding apparatus 150A shown in Embodiment 1 in outputting the pitch period found by decoding processing in first layer decoding section 152B, to second layer decoding section 153B.

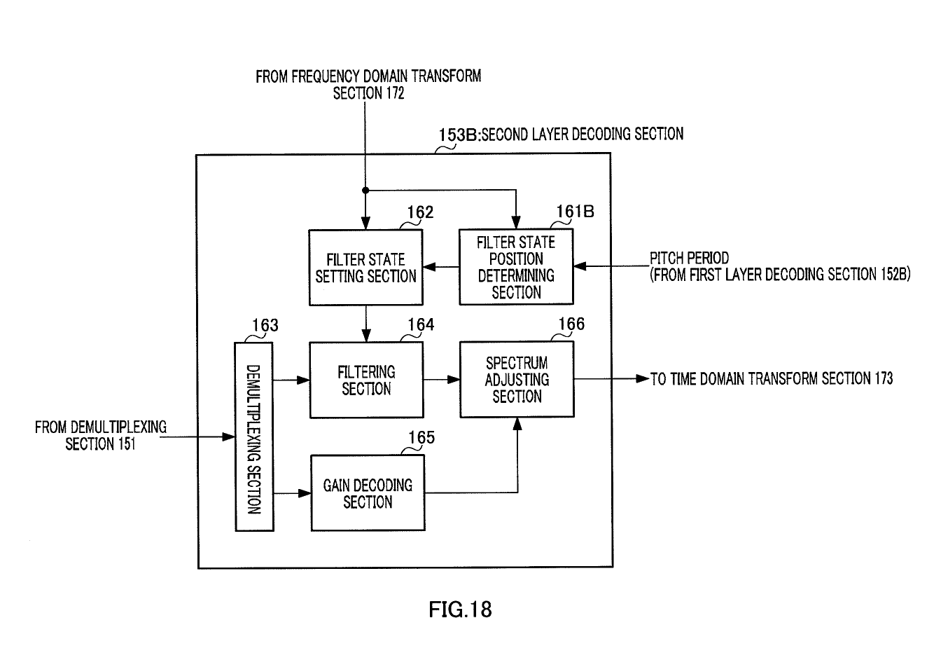

FIG. 18 is a block diagram showing main components inside second layer decoding section 153B.

Filter state position determining section 161B calculates the pitch frequency from the pitch period found in first layer decoding section 152B and uses this pitch frequency as fundamental frequency F0. Next, subbands with center frequencies at fundamental frequency F0 and its integral are set. Filter state position determining section 161B calculates average values of the amplitude values of the first layer decoded spectra of these subbands, compares the variations of these average values in the frequency domain and a threshold, and outputs information showing the frequencies at which the variations are greater than the threshold. Filter state setting section 162 receives as input, the first layer decoded spectrum S1(k) from frequency domain transform section 172 in addition to the above frequency information. Operations after this step are as shown in Embodiment 1.

As described above, according to the present embodiment, it is possible to determine the noise characteristics of a decoded spectrum using the pitch period acquired by first layer coding. Therefore, the SFM needs not be calculated, thereby reducing the amount of computation for determining the noise characteristics.

Further, although a case has been described with the present embodiment where, using subbands with center frequencies at F0 and at its integral multiples, variations in the frequency domain are found based on the maximum values or average values of the amplitude values of the first layer decoded spectra included in these subbands, it is equally possible to adopt a configuration calculating variations in the frequency domain of the amplitude values of the first layer decoded spectra at integral multiples of fundamental frequency F0. Further, it is equally possible to calculate logarithms of the amplitude spectrum and calculate variations in the frequency domain using the logarithm amplitude spectrum.

### Embodiment 3

The speech coding apparatus according to Embodiment 3 of the present invention employs a configuration determining the characteristics of a decoded spectrum using the LPC coefficients acquired by first layer coding. With this configuration, it is possible to reduce the amount of computation for determining the noise characteristics of a spectrum.

The configuration of the speech coding apparatus according to the present embodiment is the same as speech coding apparatus 200 (see FIG. 14) shown in Embodiment 2. However, the LPC coefficients found by the coding processing in first layer coding section 102B are outputted from first layer coding section 102B to second layer coding section 104B. Further, the configuration of second layer coding section 104B according to the present embodiment is the same as in second layer coding section 104B (see FIG. 15) shown in Embodiment 2.

Next, the operations of filter state position determining section 111B in second layer coding section 104B will be explained.

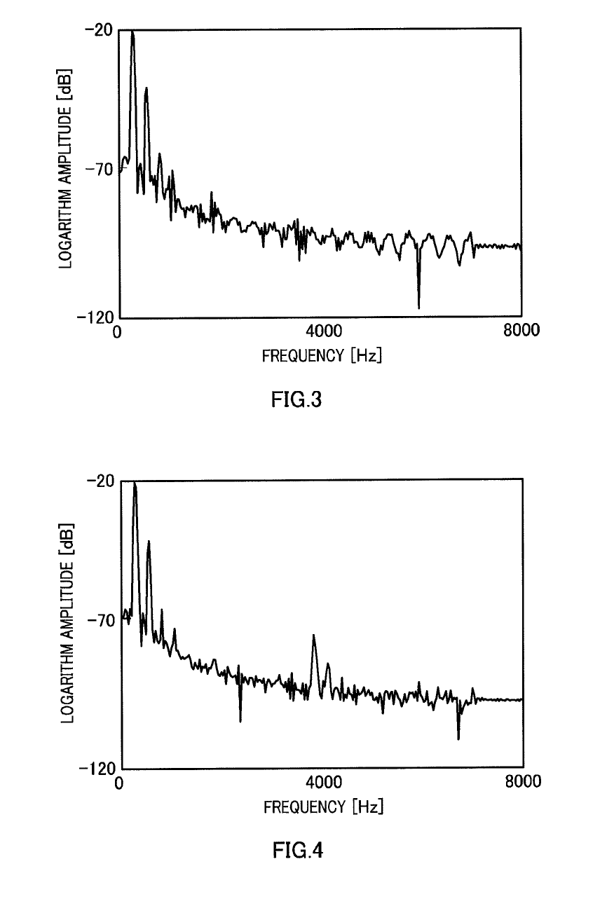

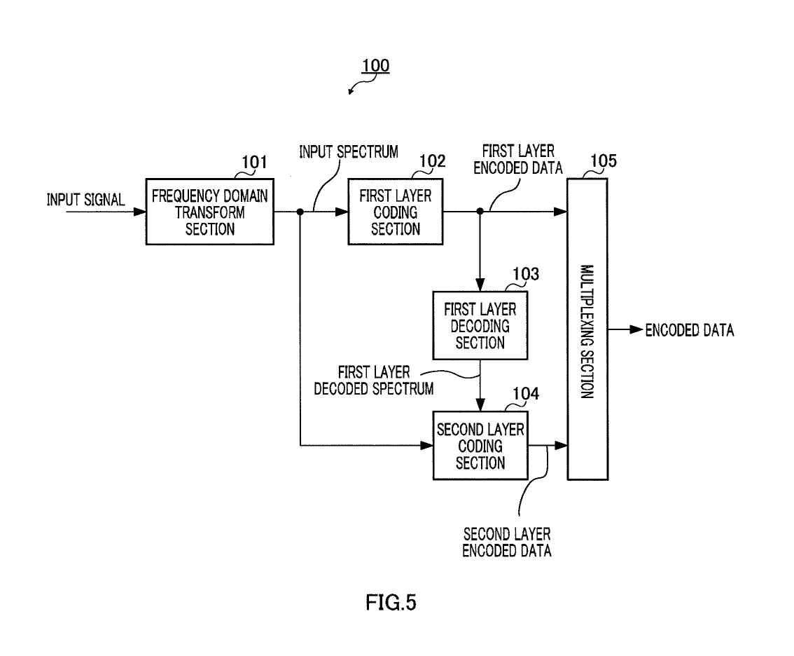

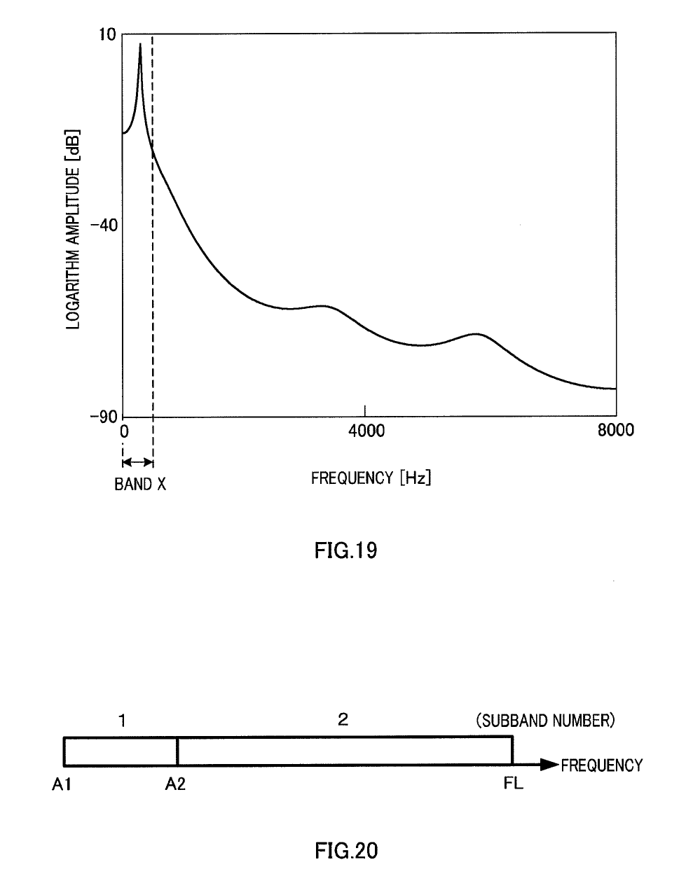

As shown in FIG. 3, in a speech signal where the harmonic structure exists in part of the low band, the energy of the spectrum envelope is likely to increase in the band where the harmonic structure exists. Although FIG. 19 shows a spectrum envelope associated with the spectrum in FIG. 3, as shown in FIG. 19, the energy of the spectrum envelope increases in the band where the harmonic structure exists (band X in the figure). Therefore, filter state position determining section 111B determines the first layer decoded spectrum that is used to set the filter state of the pitch filter, based on such feature of a spectrum envelope. That is, filter state position determining section 111B calculates a spectrum envelope using the LPC coefficients outputted from first layer coding section 102B, compares the energy of the spectrum envelope in part of the low band and the energy of the spectrum envelope in the other bands, and determines, based on the comparison result, the band of the first layer decoded spectrum that is used to set the filter state of the pitch filter.

FIG. 20 illustrates an example of a band determined in filter state position determining section 111B according to the present embodiment.

As shown in this figure, filter state position determining section 111B divides the first layer decoded spectrum into two subbands (subband numbers 1 and 2), and calculates an average energy of the spectrum envelopes of these subbands. Here, the band of subband 1 is set to include a frequency N times of the fundamental frequency F0 of an input signal (N is preferably around 4). Further, filter state position determining section 111B calculates the ratio of the average energy of the spectrum envelope in subband 2 to the average energy of the spectrum envelope in subband 1, decides that a harmonic structure exists in only part of the low band and outputs information showing frequency A2 when the ratio is greater than a threshold, and, otherwise, outputs information showing frequency A2.

Further, it is equally possible to use LSP parameters instead of LPC coefficients, as information outputted from first layer coding section 102B. For example, when the distance between LSP parameters is short, it is possible to decide that resonance occurs near the frequencies shown by the parameters. That is, the energy of the spectrum envelope near the frequencies is greater than the surrounding frequencies. Therefore, when the distance between low parameters, in particular, between LSP parameters included in subband 1 shown in FIG. 20 is found and this distance is equal to or less than a threshold, it is possible to decide that resonance occurs (i.e., the energy of the spectrum envelope is large). In this case, filter state position determining section 111B outputs information showing frequency A2. On the other hand, if the distance between LSP parameters is greater than the threshold, filter state determining section 111B outputs information showing frequency A1.

The configuration of the speech decoding apparatus according to the present embodiment is the same as speech decoding apparatus 250 (see FIG. 17) shown in Embodiment 2. However, the LPC coefficients or LSP parameters are outputted from first layer decoding section 152B to second layer decoding section 153B. Further, the configuration of second layer decoding section 153B according to the present embodiment is the same as in Embodiment 2 (see FIG. 18).

As described above, according to the present embodiment, the noise characteristics of a decoded spectrum are determined using the LPC coefficients or LSP parameters acquired by first layer coding. Therefore, the SFM needs not be calculated, so that it is possible to reduce the amount of computation for determining noise characteristics.

Embodiments of the present invention have explained above.

Further, the speech coding apparatus and speech decoding apparatus according to the present invention are not limited to above-described embodiments and can be implemented with various changes. For example, it is equally possible to employ a configuration encoding frequency information of the first layer decoded spectrum as the filter state and transmitting it to a decoding section. In this case, the decoding section can acquire more accurate frequency information, so that it is possible to improve the sound quality of a decoded signal.

Further, the present invention is applicable to a scalable configuration having two or more layers.

Further, as frequency transform, it is equally possible to use, for example, DFT (Discrete Fourier Transform), FFT (Fast Fourier Transform), DCT (Discrete Cosine Transform), MDCT (Modified Discrete Cosine Transform), filter bank.

Further, an input signal of the speech coding apparatus according to the present invention may be an audio signal in addition to a speech signal. Further, the present invention may be applied to an LPC prediction residual signal instead of an input signal.

Further, the speech coding apparatus and speech decoding apparatus according to the present invention can be included in a communication terminal apparatus and base station apparatus in mobile communication systems, so that it is possible to provide a communication terminal apparatus, base station apparatus and mobile communication systems having the same operational effect as above.

Although a case has been described with the above embodiments as an example where the present invention is implemented with hardware, the present invention can be implemented with software. For example, by describing the speech coding method according to the present invention in a programming language, storing this program in a memory and making the information processing section execute this program, it is possible to implement the same function as the speech coding apparatus of the present invention.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2006-099915, filed on Mar. 31, 2006, including the specification, drawings and abstract, is incorporated herein by reference in its entirety.

### INDUSTRIAL APPLICABILITY

The speech coding apparatus or the like according to the present invention is applicable to a communication terminal apparatus and base station apparatus in the mobile communication system.

1. A speech coding apparatus comprising:
a first coding section that encodes a low band of an input signal and generates first encoded data;
a first decoding section that decodes the first encoded data and generates a first decoded signal;
a second coding section that sets a filter state of a filter based on a spectrum of the first decoded signal and generates second encoded data by encoding a high band of the input signal using the filter; and
a determining section that determines a band of the spectrum of the first decoded signal that is used to set the filter state of the filter, according to noise characteristics of the spectrum of the first decoded signal,
wherein the second coding section sets the filter state of the filter based on the spectrum of the first decoded signal of the determined band.

2. The speech coding apparatus according to claim 1, wherein the determining section detects a band with noise characteristics equal to or greater than a predetermined level in the low band of the input signal, and determines the band as a band of the spectrum of the first decoded signal that is used to set the filter state of the filter.

3. The speech coding apparatus according to claim 1, wherein the determining section determines the noise characteristics of the spectrum of the first decoded signal using a pitch period or linear predictive coding coefficient acquired in the first coding section.

4. A decoding apparatus comprising:
a first decoding section that generates a first decoded signal by decoding first encoded data of a signal comprised of a low band indicated by the first encoded data and a high band indicated by second encoded data;
a second decoding section that sets a filter state of a filter based on a spectrum of the first decoded signal and decodes the high band of the signal by decoding the second encoded data using the filter; and
a determining section that determines a band of the spectrum of the first decoded signal that is used to set the filter state of the filter, according to noise characteristics of the spectrum of the first decoded signal,
wherein the second decoding section sets the filter state of the filter based on the spectrum of the first decoded signal in the determined band.

5. A speech coding method comprising:
a first coding step of encoding a low band of an input signal and generates a first encoded data;
a first decoding step of decoding the first encoded data and generates a first decoded signal;
a setting step of setting a filter state of a filter based on a spectrum of the first decoded signal;
a second coding step of generating second encoded data by encoding a high band of the input signal using the filter; and
a determining step of determining a band of the spectrum of the first decoded signal that is used to set the filter state of the filter, according to noise characteristics of a spectrum of the first decoded signal,
wherein the setting step sets the filter state of the filter based on the spectrum of the first decoded signal of the determined band.

6. A speech decoding method comprising:
a first decoding step of generating a first decoded signal by decoding first encoded data of a signal comprised of a low band indicated by the first encoded data and a high band indicated by second encoded data;
a setting step of setting a filter state of a filter based on a spectrum of the first decoded signal;
a second decoding step of decoding the high band of the signal by decoding the second encoded data using the filter; and
a determining of determining a band of the spectrum of the first decoded signal that is used to set the filter state of the filter according to noise characteristics of the spectrum of the first decoded signal,
wherein the determining step sets the filter state of the filter based on the spectrum of the first decoded signal in the determined band.
